(19) United States
(12) Patent Application Publication
(10) Pub. No.: US 2008/0003962 A1
(43) Pub. Date: Jan. 3, 2008

(54) Method and apparatus for providing adaptive supply voltage control of a power amplifier

(76) Inventor: Wai Lim Ngai, Poway, CA (US)

Correspondence Address: DITTHAVONG & MORI, P.C., Suite A, 10507 Braddock Road, Fairfax, VA, 22032, US

(21) Appl. No.: 11/479,955

(22) Filed: Jun. 30, 2006

(51) Int. Cl. H04B 1/18

(52) U.S. Cl. 455/179.1

(57) ABSTRACT

An approach is provided for adaptive supply voltage control of a power amplifier. A voltage detector detects a voltage swing, and a power detector detects power. A controller is coupled to the voltage detector and the power detector. The controller receives a signal specifying a required output power and determines, using the detected voltage swing and the detected power, a supply rail voltage corresponding to the required output power at a particular loading condition. A converter applies the determined supply rail voltage for generating the required output power.

### FIELD OF THE INVENTION

Various exemplary embodiments of the invention relate generally to communications.

### BACKGROUND OF THE INVENTION

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses in terms of communicating voice and data (including textual and graphical information). The variety of mobile terminals (e.g., phones), thus, has been on the rise. As such, the manufacturers are continually challenged to produce terminals with greater functionality, longer operation and smaller form factors. One important component of these devices is the power amplifier (PA).

Traditionally, power amplifiers utilized in wireless device applications require use of an isolator. For instance, the PA output connects to an isolator such that the loading of the PA can remain almost constant, regardless of load variation created by antenna impedance, which change over different operating conditions. However, to save cost and reduce the form factor, such isolator is commonly omitted in modern phones. This constraint poses a tremendous engineering challenge in the design of power amplifiers. That is, a large load variation can negatively impact the operation of these phones. Such load variation can be characterized by Voltage-Standing-Wave-Ratio (VSWR), wherein the PA is said to be designed to work for a load within certain VSWR circle.

Therefore, there is a need for an approach to provide an efficient power amplifier.

### SUMMARY OF SOME EXEMPLARY EMBODIMENTS

These and other needs are addressed by the invention, in which an approach is presented for providing adaptive supply voltage control of a power amplifier.

According to one aspect of an embodiment of the invention, an apparatus comprises a voltage detector configured to detect a voltage swing, and a power detector configured to detect power. The apparatus also comprises a controller coupled to the voltage detector and the power detector. The controller is configured to receive a signal specifying a required output power and to determine, using the detected voltage swing and the detected power, a supply rail voltage corresponding to the required output power at a particular loading condition. Further, the apparatus comprises a converter configured to apply the determined supply rail voltage for generating the required output power.

According to another aspect of an embodiment of the invention, a method comprises receiving a signal specifying a required output power. The method also comprises detecting a voltage swing, and detecting power. Further, the method comprises determining, using the detected voltage swing and the detected power, a supply rail voltage corresponding to the required output power at a particular loading condition; and applying the determined supply rail voltage to generate the required output power.

According to yet another aspect of an embodiment of the invention, an apparatus comprises means for receiving a signal specifying a required output power. The apparatus also comprises means for detecting a voltage swing, and means for detecting power. Further, the apparatus comprises means for determining, using the detected voltage swing and the detected power, a supply rail voltage corresponding to the required output power at a particular loading condition; and means for applying the determined supply rail voltage to generate the required output power.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of an communication system capable of providing adaptive supply voltage control of an isolatorless power amplifier, in accordance with various embodiments of the invention;

FIG. 2 is a diagram showing components of a power amplifier capable of supporting adaptive supply voltage control, in accordance with an embodiment of the invention;

FIG. 3 is an exemplary circuit diagram of a power amplifier capable of supporting adaptive supply voltage control, in accordance with an embodiment of the invention;

FIG. 4 is a diagram illustrating a scenario when load impedance with the power amplifier in the system of FIG. 1 is changed from a higher resistance to a lower resistance;

FIG. 5 is a diagram illustrating a scenario in which the input signal of the power amplifier of the system of FIG. 1 has been increased as to increase the transistor voltage swing to maintain an identical output power level;

FIG. 6 is a diagram illustrating shifting of the AC load line by reducing the collector rail voltage;

FIG. 7 is a flowchart of a process for achieving a desired output power from the power amplifier of the system of FIG. 1, according to one embodiment of the invention;

FIG. 8 is a diagram of hardware that can be used to implement various embodiments of the invention;

FIGS. 9A and 9B are diagrams of different cellular mobile phone systems capable of supporting various embodiments of the invention;

FIG. 10 is a diagram of exemplary components of a mobile station capable of operating in the systems of FIGS. 9A and 9B, according to an embodiment of the invention; and

FIG. 11 is a diagram of an enterprise network capable of supporting the processes described herein, according to an embodiment of the invention.

### DESCRIPTION OF THE PREFERRED EMBODIMENT

An apparatus, method, and software for providing an adaptive supply voltage control of a power amplifier are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although certain embodiments of the invention are discussed with respect to a wireless network and spread spectrum technology (e.g., Code Division Multiple Access (CDMA), Wideband CDMA (WCDMA), etc.), it is recognized by one of ordinary skill in the art that the embodiments of the inventions have applicability to any type of communication system (e.g., wired networks, etc.) and other transmission technologies (e.g., TDMA, Enhanced UTRAN (Universal Terrestrial Radio Access Network)).

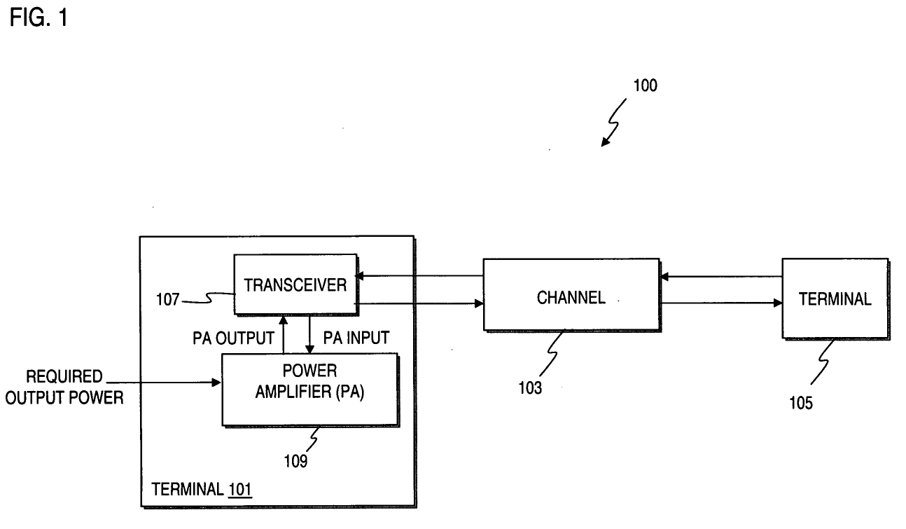

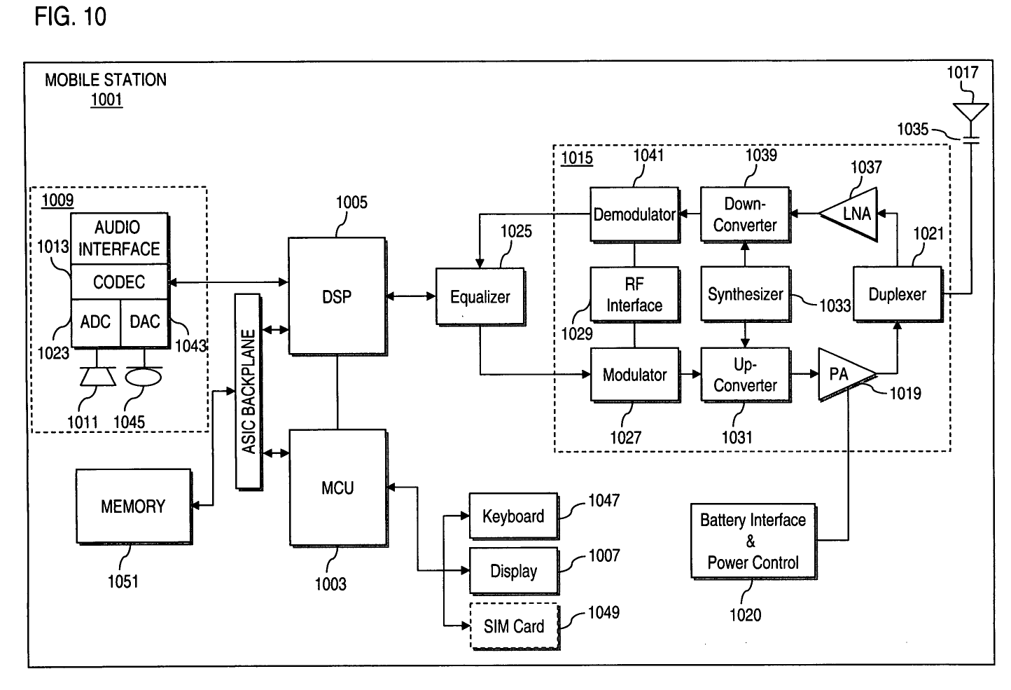

FIG. 1 is a diagram of a communication system capable of providing adaptive supply voltage control of an isolatorless power amplifier, in accordance with various embodiments of the invention. A communications system 100, which can be a wireless network or a wired system, includes a terminal 101 communicating over a channel 103 with another terminal 105. As shown, the terminal 101 includes, among other components, a transceiver 107 for transmitting and receiving signals; the terminal 101, in an exemplary embodiment, is implemented as a mobile station as described in FIG. 10. The transceiver 107 is coupled to a power amplifier (PA) 109 for amplifying signals supplied from the transceiver 107. Additionally, the transceiver 107 can include circuitry, e.g., signal processing components, for supporting communications with the terminal 105. In one embodiment, the terminal 101 is a wireless device, and thus, can possess an antenna (not shown) for transmitting and receiving Radio Frequency (RF) signals. The PA 109 also has the capability to receive an external input for specifying the required output power of the PA 109. Under this arrangement, the single control external to the PA 109 can instruct the PA 109 to determine its own supply rail voltage and quiescent current setting at any given output power and load condition.

It is recognized that, in general, when a power amplifier is designed to meet linearity requirements (e.g., as specified by Adjacent Channel Power or ACPR requirements in CDMA systems) over load variation within certain Voltage-Standing-Wave-Ratio (VSWR) circle, the worst-case condition for linearity to meet would be a particular point located on that VSWR circle (described as a particular phase on that VSWR circle). This worst-case phase on the VSWR circle is actually transformed by the circuit in between, for example, the output pin(s) of the power amplifier and the Collector/Drain of the active device. The transformed worst-case load corresponds to the maximum impedance as seen by the Collector/Drain of the active device. This stems from the fact that with limited power supply rail, the allowable voltage swing would be clipped and the highest impedance seen by Collector/Drain equates to the highest Collector/Drain swing voltage (Vₒ) at a given output power—i.e., so as long as the power amplifier is designed to clip the Collector/Drain voltage swing before ACPR requirements fail at this highest impedance condition. Any other point on or within that particular VSWR circle would mean a lower Collector/Drain voltage swing. Thus, clipping by power supply rail would be less, whereby ACPR (linearity) would be better than the worst-case condition mentioned above. In other words, there is a greater ACPR margin at any point other than the worst-case load condition within the VSWR circle. However, this guarantee in passing ACPR at worst-case indicates that it is considerably less efficient when the power amplifier is working at any other point on or within the VSWR circle.

To address the above problem, the power amplifier 109 is configured to monitor the Collector/Drain voltage swing (Vₒ) and the forward power (Pₒ) from the PA 109, the power supply rail voltage (Vᵣᵣ) is adjusted. This process provides efficient operation of the PA 109, thereby improving talk time (assuming the terminal 101 is implemented as a cellular phone).

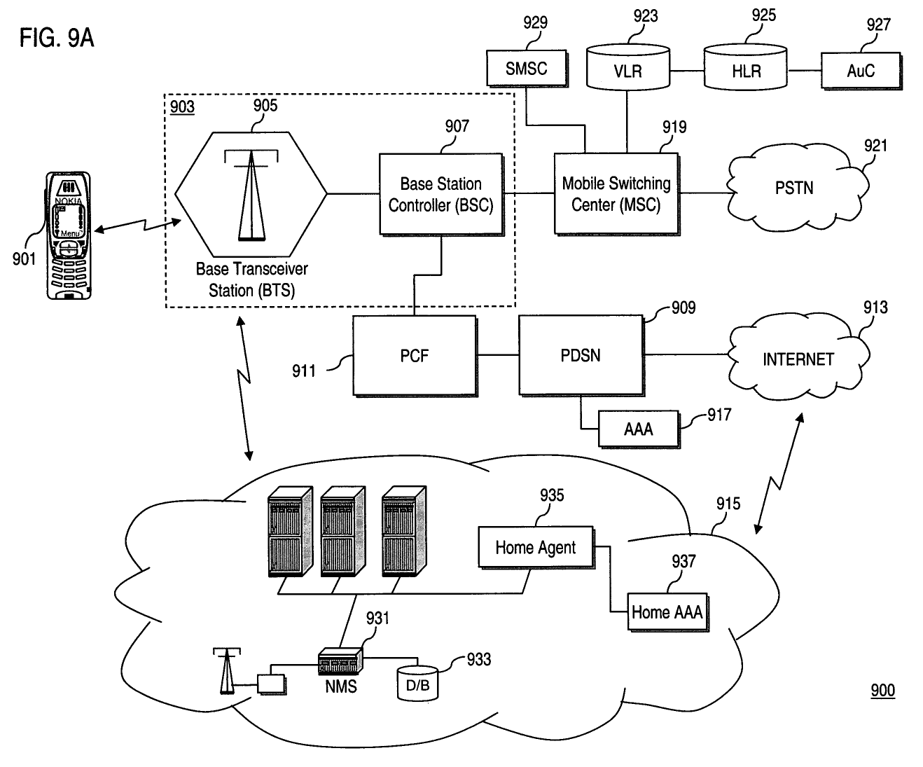

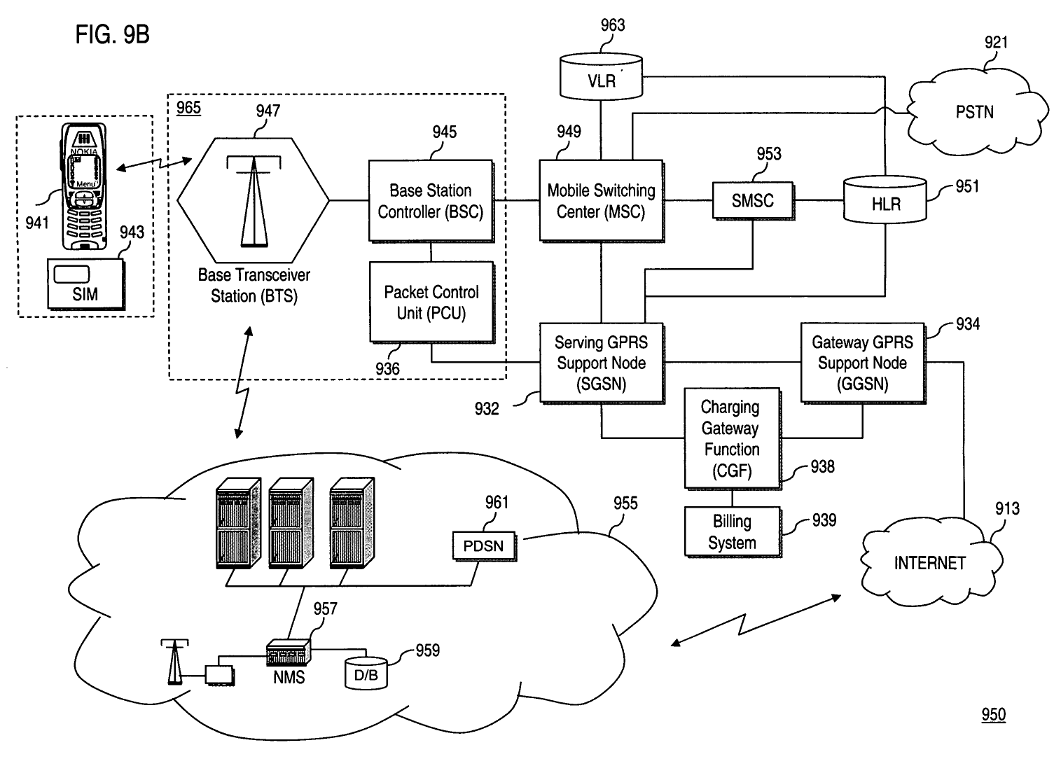

In certain embodiments, the communication system 100 is a radio network supporting multiple terminals 101, 105, as detailed with respect to FIGS. 9A and 9B.

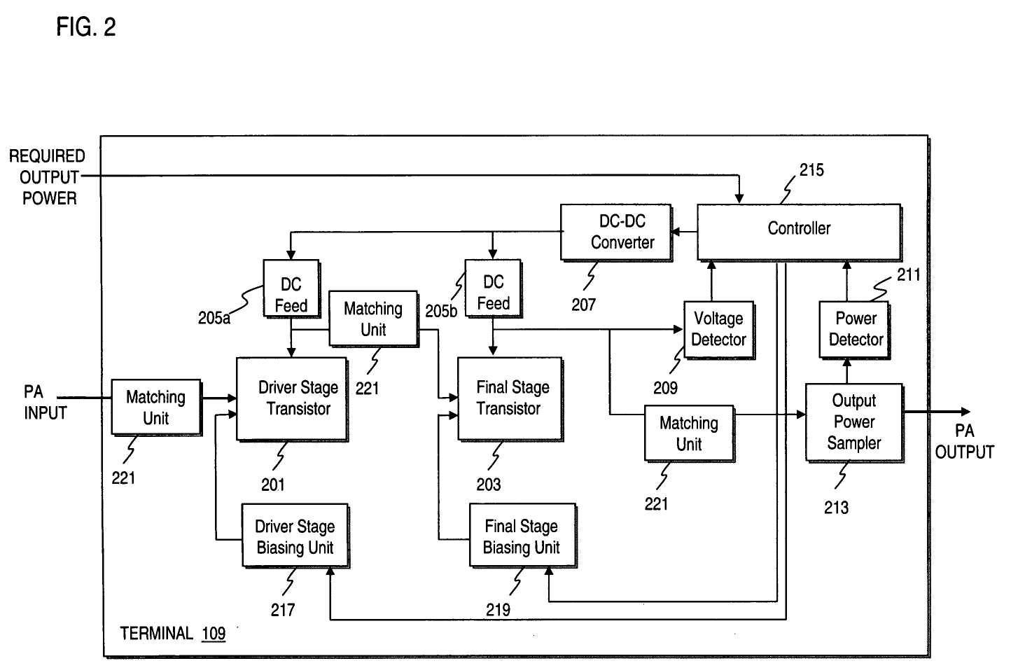

FIG. 2 is a diagram showing components of a power amplifier capable of supporting adaptive supply voltage control, in accordance with an embodiment of the invention. In this example, the PA 109 includes an input for receiving the signal to be amplified and another input for specifying the level of required power that is to be output from the PA 109. The amplification process is accomplished by a combination of a driver stage transistor 201 and a final stage transistor 203. These transistors 201, 203 may be any type of transistor including a Field Effect Transistor (FET), a Bipolar Junction Transistor (BJT), Metal-Oxide-Semiconductor (MOS) transistor, etc. For purposes of explanation, the transistors 201, 203 are described as a BJT with an emitter, a base and a collector.

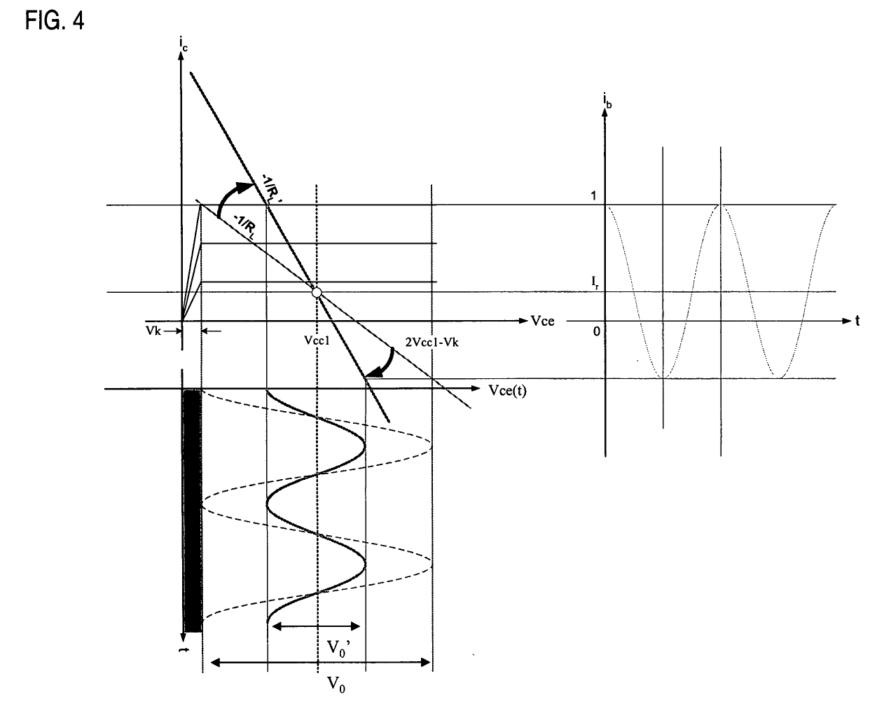

A DC-DC converter 207 supplies a collector rail voltage (V_{cc}) to the driver stage transistor 201 and final stage transistor 203 over the DC feeds 205a and 205b, respectively. The DC feed 205b couples to the power supply rail of the transistor 203, and represents the changing load impedance of the antenna (not shown). The DC-DC converter 207 can adjust the power supply rail voltage (Vᵣᵣ) to allow just enough DC (Direct Current) voltage for the required voltage swing. This adjustment can be made based on monitoring of the collector voltage swing (Vₒ) and the forward power (Pₒ) of the PA 109. The DC-DC converter 207 is utilized to improve efficiency at lower (backed-off) power; this is because lower power does not require full voltage swing as in the peak power case. In this case, efficiency at any given load condition can be optimized, as shown in FIGS. 4-6 (as represented by the horizontally shifting of load-line position to adapt load impedance change).

Specifically, the collector swing voltage (Vₒ) of the final stage transistor 203 is input to a voltage detector 209. The collector swing voltage (Vₒ) of the final stage transistor 203 is also input to an output power sampler (e.g., directional coupler) 213 through a matching unit 221. The output power sampler 213 in turn outputs the amplified signal at the PA output and feeds the amplified signal to a power detector 211. Specifically, to monitor the forward power, Pₒ, the output power sampler 213, which is connected to the output of the PA 109, samples the forward power. This sampled-forward-power is then detected by the power detector 211. The outputs of the voltage detector 209 and power detector 211 are in turn input to the controller 215. The controller 215 can then generate the required collector rail voltage, thereby providing efficient operation of the PA 109.

The driver stage biasing unit 217 receives biasing from the controller 215 and provides biasing to the driver stage transistor 201. Similarly, the final stage biasing unit 219 receives a biasing signal from the controller 215 and provides biasing to the final stage transistor 203. Matching units 221 may also be included within the PA 109 for impedance matching purposes.

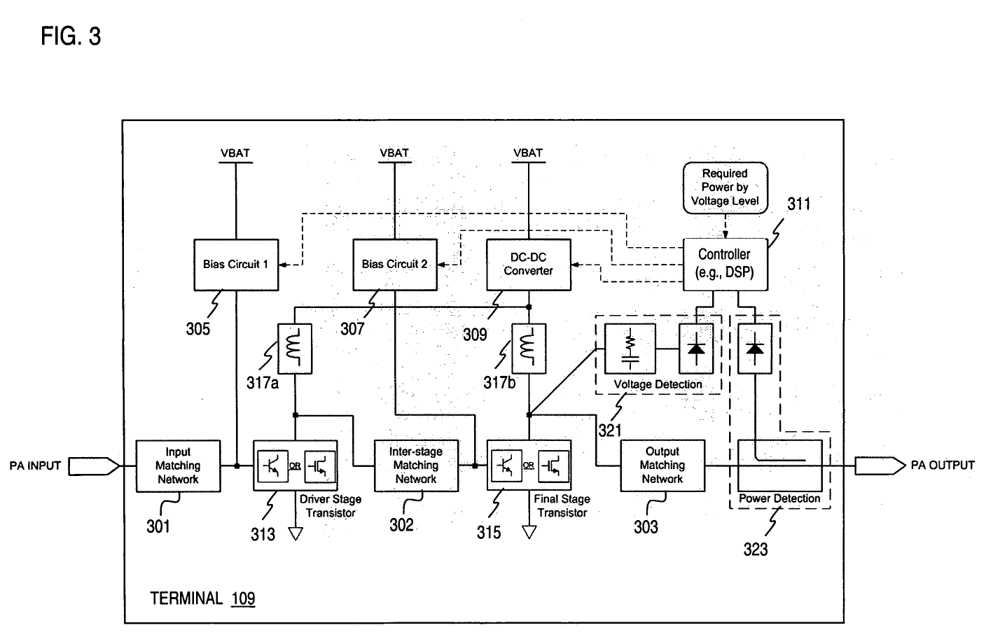

FIG. 3 is an exemplary circuit diagram of a power amplifier capable of supporting adaptive supply voltage control, in accordance with an embodiment of the invention. Under this scenario, the PA 109 include as matching units, an input matching network 301, an inter-stage matching network 302, and an output matching network 303. Bias circuits 305, 307 may be implemented by electronic bias circuits. VBATs represent the battery terminals for feeding power to the bias circuits 305, 309, as well as a DC-DC converter 309. A controller 311 (e.g., Digital Signal Processor (DSP), real-time software, or analog-controller) controls the DC-DC converter 309. The input control can either be analog voltage/current or digital representation; for example, if analog control is used, the voltage/current can be a linear or a non-linear scaled down or up version of the supply rail voltage for the worst case load condition. As previously described, by feeding Collector swing voltage (Vₒ) and the required power (Pₒ) into the controller 311, the Collector/Drain supply rail voltage (Vᵣᵣ) can be appropriately adjusted to provide sufficient DC voltage for the required (or desired) output power at a given loading condition.

In particular, the required power (Pₒ) at the PA output is fed into a controller 311 and corresponding initial input power (Pᵢ) is injected into the PA input stage. Biasing for driver stage and final stage transistors 313, 315 and required Collector rail voltage (Vᵣᵣ_{_{—}}ₘₐₓ) are calculated based on Pₒ delivering into the worst-case load impedance (Z1_max). Pᵢ is then adjusted until Pₒ is achieved in to the actual load impedance Z1 (as represented by 317). When Z1 is changed due to antenna loading variation, Pₒ will be changed and Pᵢ is then adjusted to keep the same Pₒ. Collector swing voltage (Vₒ) is measured when it is less than what Vᵣᵣ_{_{—}}ₘₐₓ is intended for; a new Vᵣᵣ is then calculated based on the measured Vₒ. This ensures that Vᵣᵣ is always optimized for given Pₒ, at any loading condition. Biasing for driver and final stages 317, 319 can also be optimized (however, they can be kept at the default values based on characterization for the worst-case impedance).

The controller 311 is coupled to a voltage detector 321, which may comprise a capacitor of high value or a resistor of high value followed by a peak/envelop detector (as shown). A power detector 323 may also utilize a peak/envelop detector or a root mean square (RMS) power detector (not shown). To avoid loading the Collector/Drain of the transistors 313, 315, one particular way of monitoring Vₒ can be implemented by using a small capacitor (i.e., high capacitance) or large resistor (i.e., high resistance), which samples the Radio Frequency (RF) voltage at the Collector/Drain and then detect the voltage swing Vₒ of the transistor 315 by using a peak/envelop detector.

Under the above arrangement, the Collector/Drain supply rail voltage (Vᵣᵣ) of the PA 109 is always adjusted to allow just enough Collector/Drain voltage swing (Vₒ) for any Output Power (Pₒ) into a variable load. Thus, the PA 109 operates at its most efficient condition, and thereby can effectively extend battery life (resulting in increased talk time of cellular phone, for example). This also yields the advantageous effect of reducing the temperature of the terminal 109.

FIG. 4 is a diagram illustrating a scenario when load impedance with the power amplifier in the system of FIG. 1 is changed from a higher resistance to a lower resistance. Specifically, the scenario involves the load impedance—as seen by the collectors of the driver and final stage transistors 201 and 203 changing—from a higher resistance, R_{L}, to a lower resistance, R_{L}′. As shown, the collector voltage swing is represented by Vₒ. The assumption is that there is no clipping in the collector voltage swing at this high load resistance situation. When the load resistance is lowered, the voltage swing Vₒ at the collector is reduced to Vₒ′, and hence the output power Pₒ is reduced to Pₒ′. That is, Pₒ represents the output power before the impedance is lowered. The changing of the load from a higher resistance to a lower one is depicted on a graph of i_{c} versus V_{ce}, where i_{c} is the collector current and V_{ce} is the collector-emitter voltage. The graph also illustrates the base current i_{b} of the transistors. This base current i_{b} varies in proportion to the input signal. The base current is biased to a level Iᵣ. The graph also depicts the collector rail voltage V_{cc1} applied to the collector as well as the saturation voltage Vₖ.

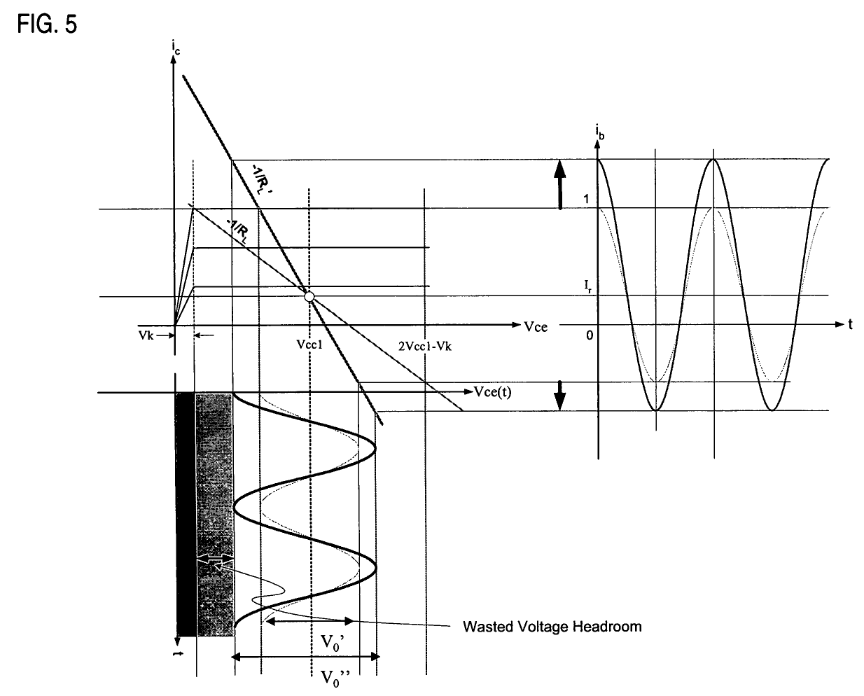

FIG. 5 is a diagram illustrating a scenario in which the input signal of the power amplifier of the system of FIG. 1 has been increased as to increase the transistor voltage swing to maintain an identical output power level. As shown, if the driving input signal is increased, the collector swing voltage is reduced to Vₒ″. The output power remains the same as before. This reduction in collector voltage swing results in collector DC-Voltage-headroom not being used for full swing, which translates into a waste of DC power.

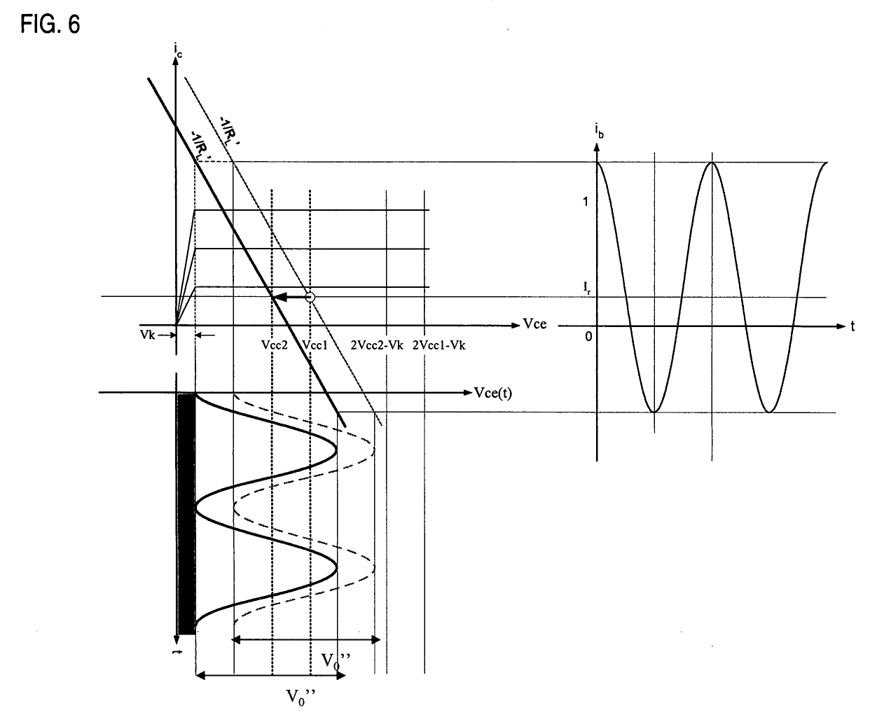

FIG. 6 is a diagram illustrating shifting of the AC load line by reducing the collector rail voltage. In particular, the graph shows the shifting of the AC (Alternating Current) load line by reducing the collector rail voltage from V_{cc1} to V_{cc2}. In this case, the wasted voltage headroom has been eliminated, thereby improving the efficiency of the PA 109. The variation in the collector rail voltage can be controlled by sensing the collector voltage swing at a given output power. This ensures there is sufficient DC Voltage for the RF swing. It is noted that the scenario shown here assumes a non-distorted waveform, but in real applications certain clipping is allowed for trading off efficiency and finite linearity requirements. Such linearity requirements are dictated by the ACPR requirements.

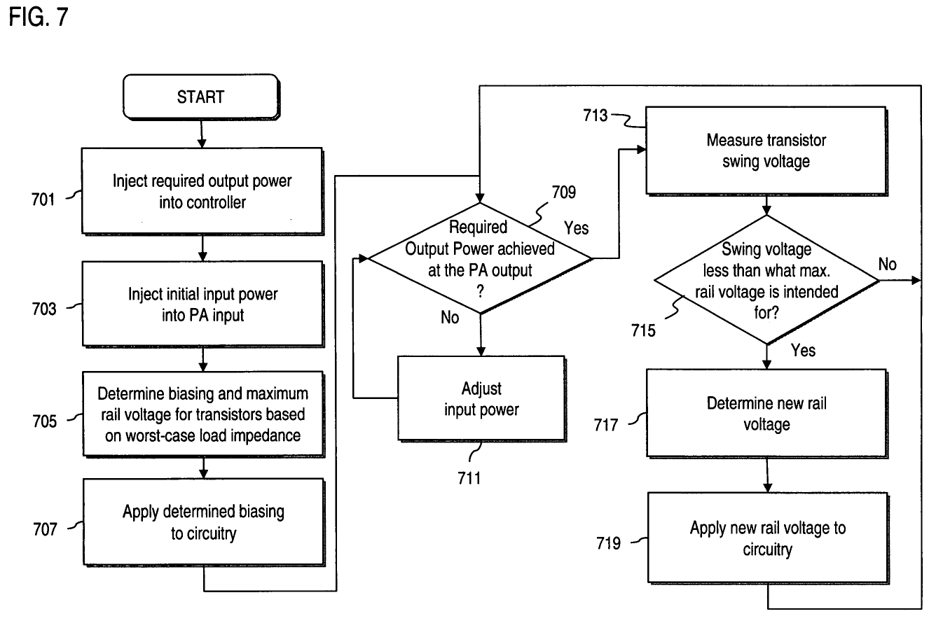

FIG. 7 is a flowchart of a process for achieving a desired output power from the power amplifier of the system of FIG. 1, according to one embodiment of the invention. In this example, to obtain the desired output power from the PA 109 (while maintaining an efficient PA operation), the output power, Pₒ, and collector voltage swing, Vₒ, are continually monitored. This monitoring permits proper adjustment of the PA input power and collector rail voltage. In step 701, the required output power is injected into the controller 215. The corresponding initial input power is supplied into the PA input, as in step 703. Next, biasing for the driver stage and final stage transistors 201, 203 and maximum required collector rail voltage (Vᵣᵣ_{_{—}}ₘₐₓ) are determined, per step 705, based on Pₒ delivering into the worst-case load impedance (Z_{L}_{_{—}}ₘₐₓ). The determined biasing is then applied to the transistors, as in step 707.

Per step 709, the output power of the PA 109 is measured by the controller 215 to determine whether the desired output power has been achieved. The output power Pᵢ, as in step 711, is adjusted until Pₒ is achieved in to the actual load impedance Z_{L}.

In step 713, the collector swing voltage Vₒ is measured. If Vₒ is less than what Vᵣᵣ_{_{—}}ₘₐₓ is intended for (as determined in step 715), a new Vᵣᵣ is determined, per step 717, based on Vₒ and is applied to the transistors 201, 203 (step 719).

Alternatively, in a balanced PA configuration (not shown), the above scheme can be implemented such that the collector voltage swing (e.g., Vₒₐ and V_{ob}) at the collectors of output transistors associated with two final stages in parallel are monitored and the maximum of the two is selected—i.e., Vₒ=max{Vₒₐ, V_{ob}}.

Additionally, the biasing for the driver stage transistor 201 and the final stage transistor 203 can be optimized; it is noted, however, that the biasing can be kept at a default value based on characterization for the worst-case impedance.

In one embodiment, the described process is repeated every power control cycle; e.g., every 1.25 ms. This process advantageously ensures that Vᵣᵣ is optimized for a given Pₒ at any loading condition. The predetermined duration (e.g., 1.25 ms) is considered a short duration relative to the load variation introduced by the operational condition change of the antenna. Under such condition, the PA 109 operates at its most efficient state with respect to the load variation.

One of ordinary skill in the art would recognize that the processes for providing an adaptive supply voltage control of a power amplifier may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

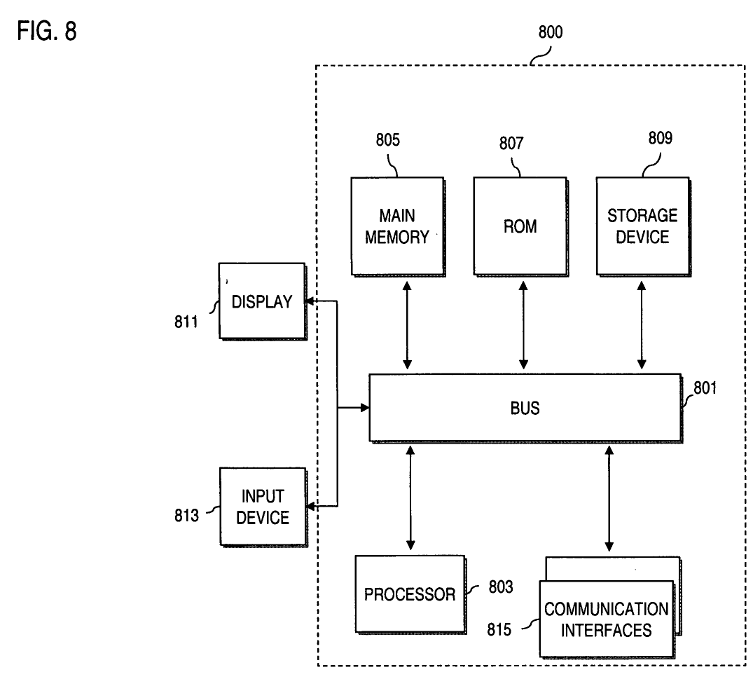

FIG. 8 illustrates exemplary hardware upon which various embodiments of the invention can be implemented. A computing system 800 includes a bus 801 or other communication mechanism for communicating information and a processor 803 coupled to the bus 801 for processing information. The computing system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computing system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computing system 800 may be coupled via the bus 801 to a display 811, such as a liquid crystal display, or active matrix display, for displaying information to a user. An input device 813, such as a keyboard including alphanumeric and other keys, may be coupled to the bus 801 for communicating information and command selections to the processor 803. The input device 813 can include a cursor control, such as a mouse, a trackball, or cursor direction keys, for communicating direction information and command selections to the processor 803 and for controlling cursor movement on the display 811.

According to various embodiments of the invention, the processes described herein can be provided by the computing system 800 in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 800 also includes at least one communication interface 815 coupled to bus 801. The communication interface 815 provides a two-way data communication coupling to a network link (not shown). The communication interface 815 sends and receives electrical, electromagnetic, or optical signals that carry digital data streams representing various types of information. Further, the communication interface 815 can include peripheral interface devices, such as a Universal Serial Bus (USB) interface, a PCMCIA (Personal Computer Memory Card International Association) interface, etc.

The processor 803 may execute the transmitted code while being received and/or store the code in the storage device 809, or other non-volatile storage for later execution. In this manner, the computing system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIGS. 9A and 9B are diagrams of different cellular mobile phone systems capable of supporting various embodiments of the invention. FIGS. 9A and 9B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 900 includes mobile stations 901 (e.g., handsets, terminals, stations, units, devices, or any type of interface to the user (such as “wearable” circuitry, etc.)) in communication with a Base Station Subsystem (BSS) 903. According to one embodiment of the invention, the radio network supports Third Generation (3G) services as defined by the International Telecommunications Union (ITU) for International Mobile Telecommunications 2000 (IMT-2000).

In this example, the BSS 903 includes a Base Transceiver Station (BTS) 905 and Base Station Controller (BSC) 907. Although a single BTS is shown, it is recognized that multiple BTSs are typically connected to the BSC through, for example, point-to-point links. Each BSS 903 is linked to a Packet Data Serving Node (PDSN) 909 through a transmission control entity, or a Packet Control Function (PCF) 911. Since the PDSN 909 serves as a gateway to external networks, e.g., the Internet 913 or other private consumer networks 915, the PDSN 909 can include an Access, Authorization and Accounting system (AAA) 917 to securely determine the identity and privileges of a user and to track each user's activities. The network 915 comprises a Network Management System (NMS) 931 linked to one or more databases 933 that are accessed through a Home Agent (HA) 935 secured by a Home AAA 937.

Although a single BSS 903 is shown, it is recognized that multiple BSSs 903 are typically connected to a Mobile Switching Center (MSC) 919. The MSC 919 provides connectivity to a circuit-switched telephone network, such as the Public Switched Telephone Network (PSTN) 921. Similarly, it is also recognized that the MSC 919 may be connected to other MSCs 919 on the same network 900 and/or to other radio networks. The MSC 919 is generally collocated with a Visitor Location Register (VLR) 923 database that holds temporary information about active subscribers to that MSC 919. The data within the VLR 923 database is to a large extent a copy of the Home Location Register (HLR) 925 database, which stores detailed subscriber service subscription information. In some implementations, the HLR 925 and VLR 923 are the same physical database; however, the HLR 925 can be located at a remote location accessed through, for example, a Signaling System Number 9 (SS7) network. An Authentication Center (AuC) 927 containing subscriber-specific authentication data, such as a secret authentication key, is associated with the HLR 925 for authenticating users. Furthermore, the MSC 919 is connected to a Short Message Service Center (SMSC) 929 that stores and forwards short messages to and from the radio network 900.

During typical operation of the cellular telephone system, BTSs 905 receive and demodulate sets of reverse-link signals from sets of mobile units 901 conducting telephone calls or other communications. Each reverse-link signal received by a given BTS 905 is processed within that station. The resulting data is forwarded to the BSC 907. The BSC 907 provides call resource allocation and mobility management functionality including the orchestration of soft handoffs between BTSs 905. The BSC 907 also routes the received data to the MSC 919, which in turn provides additional routing and/or switching for interface with the PSTN 921. The MSC 919 is also responsible for call setup, call termination, management of inter-MSC handover and supplementary services, and collecting, charging and accounting information. Similarly, the radio network 900 sends forward-link messages. The PSTN 921 interfaces with the MSC 919. The MSC 919 additionally interfaces with the BSC 907, which in turn communicates with the BTSs 905, which modulate and transmit sets of forward-link signals to the sets of mobile units 901.

As shown in FIG. 9B, the two key elements of the General Packet Radio Service (GPRS) infrastructure 950 are the Serving GPRS Supporting Node (SGSN) 932 and the Gateway GPRS Support Node (GGSN) 934. In addition, the GPRS infrastructure includes a Packet Control Unit (PCU) 936 and a Charging Gateway Function (CGF) 938 linked to a Billing System 939. A GPRS the Mobile Station (MS) 941 employs a Subscriber Identity Module (SIM) 943.

The PCU 936 is a logical network element responsible for GPRS-related functions such as air interface access control, packet scheduling on the air interface, and packet assembly and re-assembly. Generally the PCU 936 is physically integrated with the BSC 945; however, it can be collocated with a BTS 947 or a SGSN 932. The SGSN 932 provides equivalent functions as the MSC 949 including mobility management, security, and access control functions but in the packet-switched domain. Furthermore, the SGSN 932 has connectivity with the PCU 936 through, for example, a Fame Relay-based interface using the BSS GPRS protocol (BSSGP). Although only one SGSN is shown, it is recognized that that multiple SGSNs 931 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 945, any given BSC 945 generally interfaces with one SGSN 932. Also, the SGSN 932 is optionally connected with the HLR 951 through an SS7 based interface using GPRS enhanced Mobile Application Part (MAP) or with the MSC 949 through an SS7-based interface using Signaling Connection Control Part (SCCP). The SGSN/HLR interface allows the SGSN 932 to provide location updates to the HLR 951 and to retrieve GPRS-related subscription information within the SGSN service area. The SGSN/MSC interface enables coordination between circuit-switched services and packet data services such as paging a subscriber for a voice call. Finally, the SGSN 932 interfaces with a SMSC 953 to enable short messaging functionality over the network 950.

The GGSN 934 is the gateway to external packet data networks, such as the Internet 913 or other private customer networks 955. The network 955 comprises a Network Management System (NMS) 957 linked to one or more databases 959 accessed through a PDSN 961. The GGSN 934 assigns Internet Protocol (IP) addresses and can also authenticate users acting as a Remote Authentication Dial-In User Service host. Firewalls located at the GGSN 934 also perform a firewall function to restrict unauthorized traffic. Although only one GGSN 934 is shown, it is recognized that a given SGSN 932 may interface with one or more GGSNs 933 to allow user data to be tunneled between the two entities as well as to and from the network 950. When external data networks initialize sessions over the GPRS network 950, the GGSN 934 queries the HLR 951 for the SGSN 932 currently serving a MS 941.

The BTS 947 and BSC 945 manage the radio interface, including controlling which Mobile Station (MS) 941 has access to the radio channel at what time. These elements essentially relay messages between the MS 941 and SGSN 932. The SGSN 932 manages communications with an MS 941, sending and receiving data and keeping track of its location. The SGSN 932 also registers the MS 941, authenticates the MS 941, and encrypts data sent to the MS 941.

FIG. 10 is a diagram of exemplary components of a mobile station (e.g., handset) capable of operating in the systems of FIGS. 9A and 9B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system (e.g., systems of FIG. 9A or 9B), via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

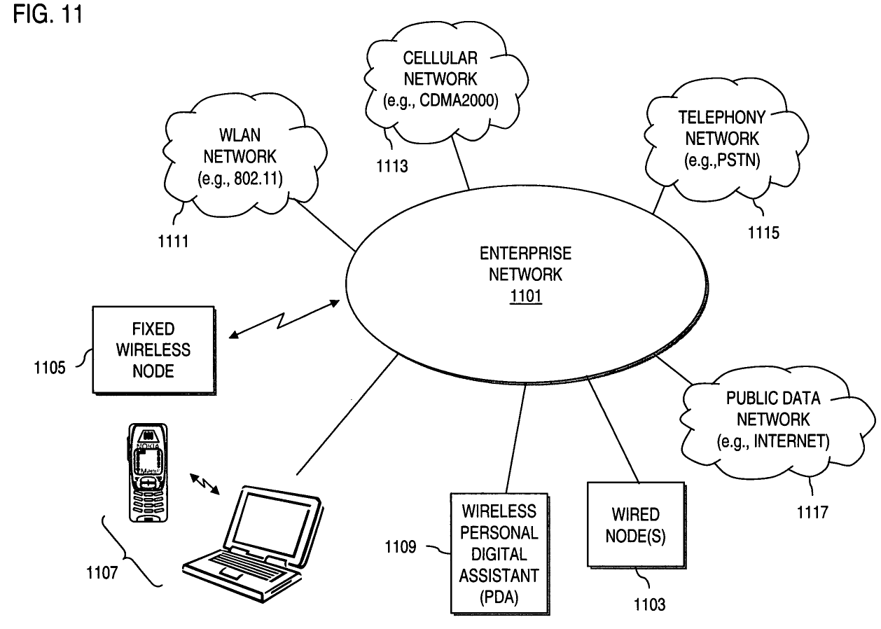

FIG. 11 shows an exemplary enterprise network, which can be any type of data communication network utilizing packet-based and/or cell-based technologies (e.g., Asynchronous Transfer Mode (ATM), Ethernet, IP-based, etc.). The enterprise network 1101 provides connectivity for wired nodes 1103 as well as wireless nodes 1105-1109 (fixed or mobile), which are each configured to perform the processes described above. The enterprise network 1101 can communicate with a variety of other networks, such as a WLAN network 1111 (e.g., IEEE 802.11), a cdma2000 cellular network 1113, a telephony network 1116 (e.g., PSTN), or a public data network 1117 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus comprising:
a voltage detector configured to detect a voltage swing;
a power detector configured to detect power;
a controller coupled to the voltage detector and the power detector, the controller being configured to receive a signal specifying a required output power and to determine, using the detected voltage swing and the detected power, a supply rail voltage corresponding to the required output power at a particular loading condition; and
a converter configured to apply the determined supply rail voltage for generating the required output power.

2. An apparatus according to claim 1, further comprising:
a first DC feed and a second DC feed collectively representing the particular loading condition and being coupled to the converter;
a driver stage circuit coupled to the first DC feed, the driver stage circuit being configured to receive the supply rail voltage; and
a final stage circuit coupled to the second DC feed, the driver stage circuit being configured to receive the supply rail voltage.

3. An apparatus according to claim 2, further comprising:
a first matching network configured to receive an input signal to be amplified, the first matching network being coupled to the driver stage circuit;
a second matching network coupled to the first DC feed and the final stage circuit; and
a third matching network coupled to the second DC feed and the power detector.

4. An apparatus according to claim 2, wherein the driver stage circuit includes a first transistor, and the second biasing circuit includes a second transistor, the apparatus further comprising:
a first biasing circuit coupled to the driver stage circuit to bias the first transistor; and
a second biasing circuit coupled to the final stage circuit to bias the second transistor.

5. An apparatus according to claim 4, wherein the detected voltage swing corresponds to the second transistor.

6. An apparatus according to claim 1, further comprising:
an output power sampler configured to generate the power to the power detector.

7. An apparatus according to claim 1, wherein the particular loading condition represents a variable antenna load under a particular condition.

8. An apparatus according to claim 1, wherein the controller includes a digital signal processor (DSP), a real-time software, or an analog-controller.

9. An apparatus according to claim 1, wherein the converter is configured to provide DC-to-DC voltage conversion.

10. An apparatus according to claim 1, wherein the voltage detector is configured to provide peak envelope detection or root mean square (RMS) power detection.

11. A system comprising the apparatus of claim 1, the system further comprising:
a transceiver coupled to the apparatus, wherein the apparatus is configured to amplify a voice signal, the transceiver being configured to transmit the amplified voice signal over a wireless network.

12. A method comprising:
receiving a signal specifying a required output power;
detecting a voltage swing;
detecting power;
determining, using the detected voltage swing and the detected power, a supply rail voltage corresponding to the required output power at a particular loading condition; and
applying the determined supply rail voltage to generate the required output power.

13. A method according to claim 12, wherein the determined supply rail voltage is applied to a driver stage circuit over a first DC feed, and to a final stage circuit over second DC feed.

14. A method according to claim 12, further comprising:
generating a first bias signal to bias the driver stage circuit; and
generating a second bias signal to bias the final stage circuit.

15. A method according to claim 14, wherein the detected voltage swing corresponds to the final stage circuit.

16. A method according to claim 12, further comprising:
generating the power by a output power sampler; and
supplying the power to a power detector for the detection of the power.

17. A method according to claim 12, wherein the particular loading condition represents a variable antenna load under a particular condition.

18. A method according to claim 12, wherein the determining step is performed by a controller that includes a digital signal processor (DSP), a real-time software, or an analog-controller.

19. A method according to claim 12, wherein the applying step is performed by a converter that is configured to provide DC-to-DC voltage conversion.

20. A method according to claim 12, wherein the step of detecting the voltage swing is performed by a voltage detector that is configured to provide peak envelope detection or root mean square (RMS) power detection.

21. An apparatus comprising:
means for receiving a signal specifying a required output power;
means for detecting a voltage swing;
means for detecting power;
means for determining, using the detected voltage swing and the detected power, a supply rail voltage corresponding to the required output power at a particular loading condition; and
means for applying the determined supply rail voltage to generate the required output power.

22. A system comprising the apparatus of claim 21, the system further comprising:
means for generating a voice signal to be amplified by the apparatus; and
transceiving means for transmitting the voice signal over a radio communication channel.
